(19) United States
(12) Patent Application Publication
(10) Pub. No.: US 2018/0233268 A1
(43) Pub. Date: Aug. 16, 2018

(54) MAGNETIC CORE COMPONENT AND CHIP INDUCTOR

(71) Applicant: NTN CORPORATION, Osaka (JP)

(72) Inventors: Kayo SAKAI, Mie (JP); Eiichirou SHIMAZU, Mie (JP); Shinji MIYAZAKI, Mie (JP); Takayuki ODA, Mie (JP)

(21) Appl. No.: 15/516,411

(22) PCT Filed: Sep. 18, 2015
(86) PCT No.: PCT/JP2015/076673

§ 371 Date: Apr. 2, 2017

(30) Foreign Application Priority Data
Oct. 1, 2014 (JP) 2014-203334

(51) Int. Cl. H01F 27/255; H01F 27/26; H01F 27/28; H01F 27/06

(52) U.S. Cl. CPC H01F 27/255; H01F 27/06; H01F 27/2823; H01F 27/263

(57) ABSTRACT

To provide a magnetic core component capable of suppressing leakage flux while suppressing the number of molds required at the time of molding, and a chip inductor using the same. A magnetic core component (1) includes a winding shaft portion (1a) for winding a winding wire (4); is formed by joining two half-members (2, 3), which are magnetic bodies and have the same shape; includes a leg portion (1b) arranged at both ends of the winding shaft portion (1a) and a cover portion (1c) arranged across one end of the leg portions in parallel with the winding shaft portion (1a); and has a joining surface (1d) which is formed in the winding shaft portion (1a) and the cover portion (1c) and which is a surface non-perpendicular to an axial direction of the winding shaft portion (1a).

### TECHNICAL FIELD

The present invention relates to a magnetic core component for a chip inductor used in an electronic circuit, and a chip inductor that uses the magnetic core component.

### BACKGROUND ART

With recent trend toward miniaturization, higher frequency, and larger current of electric equipment and electronic equipment, a magnetic core component is demanded to support this trend as well. In particular, further miniaturization and higher performance are demanded on a surface mounting type chip inductor used in an electronic circuit. A general structure of a chip inductor is shown in FIG. 4(a). In each of FIGS. 4(a) and 4(b), the left view is a plan view, and the right view is a front view. A magnetic core component 11 used in the chip inductor has a structure in which a core 12 referred to as a bobbin type, and a plate-shaped I-type core 13 arranged at an upper part of the core 12 are combined. Although the illustration is omitted, a winding wire is wound around the bobbin type core 12 to form a coil, and an electrode unit that acts as a contact with a substrate and the like is arranged at a lower part of a leg portion 12a of the bobbin type core 12, where a terminal of the winding wire is connected to the electrode unit. The I-type core 13 is arranged to form a magnetic path for suppressing leakage flux.

As a conventional chip inductor having a structure close to such structure, for example, a surface mounted closed magnetic coil including a column shaped first core made of conductive magnetic material having a winding wire portion at a central part, and a substantially saddle shaped second core made of conductive magnetic material arranged at an upper part of the first core has been proposed (see Patent document 1).

### PRIOR ART DOCUMENTS

### Patent Documents

Patent document 1: Japanese Patent Application Laid-Open Publication No. 2012-84776

### SUMMARY OF THE INVENTION

### Problem to be Solved by the Invention

However, the material property of ferrite material, which is the current mainstream for the material of the magnetic core component used in the chip inductor, has reached its limits, and a new material is being searched. The ferrite material is being replaced with a new material such as sendust, amorphous foil strip, and the like, but only in limited fields. Amorphous powder material excelling in magnetic property is now available, but is not so widely used as the moldability is poor compared to the conventional material.

Molding a powder magnetic core component from the powdered magnetic material places restrictions on the shape. Furthermore, the number of molds needs to be suppressed to a minimum to reduce cost. When forming the magnetic core component of a conventional shape shown in FIG. 4(a), molds (two) for forming the bobbin type core 12 and the I-type core 13, respectively, are required.

As a measure for preventing increase in the number of molds, a shape shown in FIG. 4(b) is considered. Such magnetic core component 14 is obtained by combining cores 15, 16 of the same shape divided along a surface perpendicular to an axial direction of a winding shaft portion at a central position of the winding shaft portion. However, if an area of a joining part divided as shown in the figure is about the same as a magnetic path cross-sectional area, mutual contacting area lowers by the influence of shape error and surface roughness. A gap thus easily forms, and increase in leakage flux becomes a concern. Furthermore, the electrode position of the leg portion becomes outside the dimensional tolerance due to the dimensional tolerance of the joining part, whereby attachment to the substrate may become difficult.

To overcome such problem, it is an object of the present invention to provide a magnetic core component capable of suppressing leakage flux while suppressing the number of molds required at the time of molding, and a chip inductor using the same.

### Means for Solving the Problem

A magnetic core component of the present invention relates to a magnetic core component including a winding shaft portion for winding a winding wire, where the magnetic core component is characterized in being formed by joining two half-members, which are magnetic bodies and have the same shape, at least one part of a joining surface being a surface non-perpendicular to an axial direction of the winding shaft portion.

The magnetic core component is characterized in including a leg portion arranged at both ends of the winding shaft portion, and a cover portion arranged across one end of the leg portions in parallel with the winding shaft portion, the joining surface being formed in the winding shaft portion and the cover portion.

The half-member is characterized in being a compression molded body of a magnetic material. Furthermore, the two half-members are characterized in having complementary fit-in shapes that position the members at respective joining parts.

A chip inductor of the present invention is characterized in being obtained by winding a winding wire around a winding shaft portion of the magnetic core component of the present invention and forming a coil.

### Effect of the Invention

The magnetic core component of the present invention is obtained by joining two half-members, which are magnetic bodies and have the same shape, where at least a part of the joining surface is a surface non-perpendicular to the axial direction of the winding shaft portion, and thus the area of the joining surface of the two half-members becomes large compared to the area of the magnetic path cross-section (plane perpendicular to the axial direction of the winding shaft portion in which the winding wire is wound to form the coil), the gap by the influence of shape error and surface roughness between the members becomes small, and the leakage flux can be suppressed when adopted for the chip inductor. Since the mold used at the time of molding is one type, the manufacturing cost can be reduced.

The magnetic core component of the present invention includes the leg portion arranged at both ends of the winding shaft portion and the cover portion arranged across one end of the leg portions in parallel with the winding shaft portion, and the joining surface is formed in the winding shaft portion and the cover portion, so that the leakage flux can be suppressed when adopted for the chip inductor, as described above, while adopting the magnetic core component having the same shape as the conventional product in which the bobbin type core and the I-type core are combined.

The half-member is a compression molded body of a magnetic material, and thus can be inexpensively manufactured and easily miniaturized compared to injection molding.

The two-half members have complementary fit-in shapes that position the members at the respective joining parts, so that the electrode position can be prevented from going outside the dimensional tolerance.

The chip inductor of the present invention uses the magnetic core component and is obtained by winding the winding wire around the winding shaft portion of the magnetic core component and forming the coil, so that the leakage flux can be suppressed to a minimum while reducing the manufacturing cost.

### BRIEF DESCRIPTION OF THE DRAWINGS

FIGS. 1(a) and 1(b) are a front view and the like showing one example of a magnetic core component and a chip inductor of the present invention.

FIG. 2 is an enlarged view of a joining part.

FIGS. 3(a) to 3(e) are front views and plan views showing another example of the magnetic core component of the present invention.

FIGS. 4(a) and 4(b) are front views and plan views showing a conventional magnetic core component and the like.

### MODE FOR CARRYING OUT THE INVENTION

A chip inductor of the present invention is a chip inductor particularly effective in a surface mounting type used in an electronic circuit of electric/electronic equipment and the like. This type of chip inductor is small, and specifically, an axial length of the magnetic core component is smaller than or equal to about 15 mm.

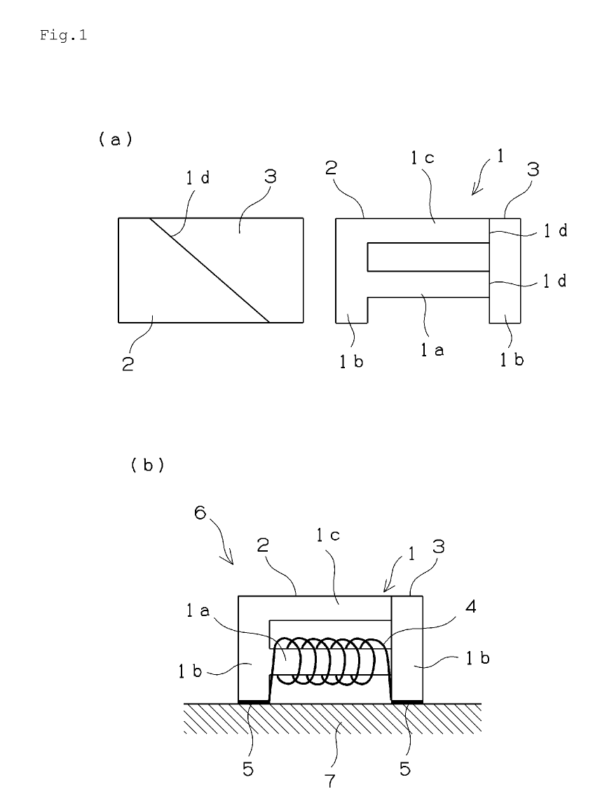

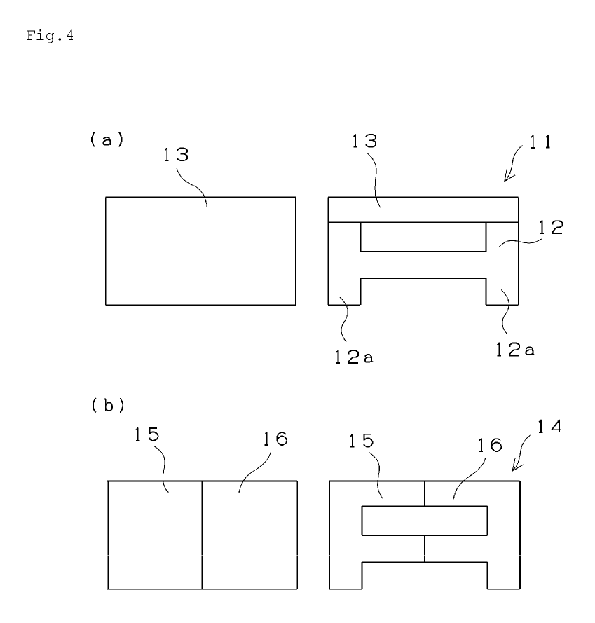

One example of a magnetic core component and a chip inductor of the present invention will be described based on FIGS. 1(a) and 1(b). FIG. 1(a) is a front view (right view) and a plan view (left view) of the magnetic core component, and FIG. 1(b) is a front view of a chip inductor using the magnetic core component of FIG. 1(a). As shown in FIG. 1(a), a magnetic core component 1 of the present invention includes a winding shaft portion 1a for winding a winding wire, a leg portion 1b arranged at both ends of the winding shaft portion 1a, and a cover portion 1c arranged across upper ends of the leg portions 1b, 1b in parallel with the winding shaft portion 1a. The shape of the magnetic core component 1 is the same as the shape of the conventional magnetic core component (see FIG. 4(a) in which the bobbin type core and the I-type core are combined. In the magnetic core component 1, the cover portion 1c plays the role of the I-type core, and forms a magnetic path for suppressing the leakage flux.

The magnetic core component 1 is formed by joining two half-members 2, 3, which are magnetic bodies and have the same shape, where at least one part of a joining surface 1d is a surface non-perpendicular to an axial direction of the winding shaft portion 1a. In an example shown in FIG. 1(a), the respective half-members have a shape in which a right triangular portion (tapered portion) and the leg portion are combined when seen in plan view. The half-member 2 and the half-member 3 have the same shape, and can be manufactured with one type of mold. The joining surface 1d is formed as one surface inclined with respect to the axial direction of the winding shaft portion 1a. The joining surface 1d is formed in the winding shaft portion 1a and the cover portion 1c, and is not formed in the leg portion 1b.

As shown in FIG. 1(b), a chip inductor 6 of the present invention uses the magnetic core component 1 described above, and winds a winding wire 4 around the winding shaft portion la of the magnetic core component 1 to form a coil. A pair of electrode units 5 is arranged at a lower part of the leg portion 1b of the magnetic core component 1, where each terminal of the winding wire 4 is connected to the respective electrode units 5. The chip inductor 6 is connected to an electronic circuit of a substrate 7 by way of the electrode unit 5. In the chip inductor 6 configured as above, a flux path in which the current exits from one axial end of the winding shaft portion 1a, passes the leg portion 1b and through the cover portion 1c to return to the other axial end of the winding shaft portion 1a is formed when the current is flowed through the coil. In the winding shaft portion 1a and the cover portion 1c, a direction of magnetic field line is a direction along the axial direction of the winding shaft portion.

Assuming that a surface perpendicular to the axial direction of the winding shaft portion, as shown in FIG. 4(b), is the joining surface, a joining area and the magnetic path cross-sectional area become almost the same, which is the smallest for the joining area of the two members, and the actual contacting area becomes small due to the influence of shape error and surface roughness, and hence the gap between the members becomes large. On the contrary, a wide joining area can be ensured and the actual contacting area also becomes large by adopting the joint shape shown in FIG. 1(a), and hence the gap between the members can be reduced, and the leakage flux can be suppressed compared to the shape shown in FIG. 4(b).

As shown in FIG. 1(b), the chip inductor 6 is connected to the electronic circuit of the substrate 7 byway of the pair of electrode units 5 arranged at the lower parts of the leg portions 1b of the magnetic core component 1. One leg portion 1b is provided on each of the half-members 2, 3, and thus when the joining position of the half-members shifts, the position of the electrode unit 5 also shifts. The chip inductor 6 of the present invention is small, and thus may go beyond the dimensional tolerance even with a slight shift, which may arise a problem in the attachment to the substrate.

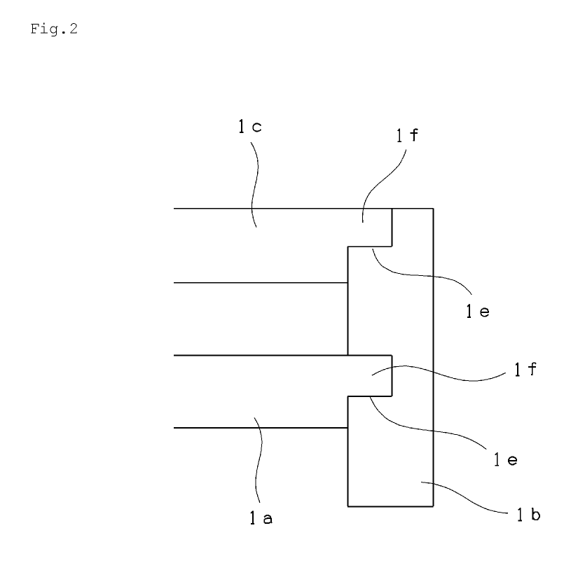

As a measure therefor, in the half-members 2, 3, the respective joining parts preferably have complementary fit-in shapes for positioning both members. For example, as shown in FIG. 2, which is an enlarged view of the joining part, a recess 1e is formed in the leg portion 1b, and a projection 1f that can be fitted into the recess 1e is formed in the winding shaft portion 1a and the cover portion 1c. The recess 1e and the projection 1f are complementary shapes, and an accurate positioning of the half-members is realized by fitting the recess and the projection. The electrode unit of the leg portion 1b is thus also positioned, and can be prevented from going beyond the dimensional tolerance. The complementary fit-in shape is not limited to the shape shown in the figure, and any shape can be adopted as long as the half-members have the same shapes and have positionable shapes. However, a simple shape as shown in the figure is preferred to allow compression molding.

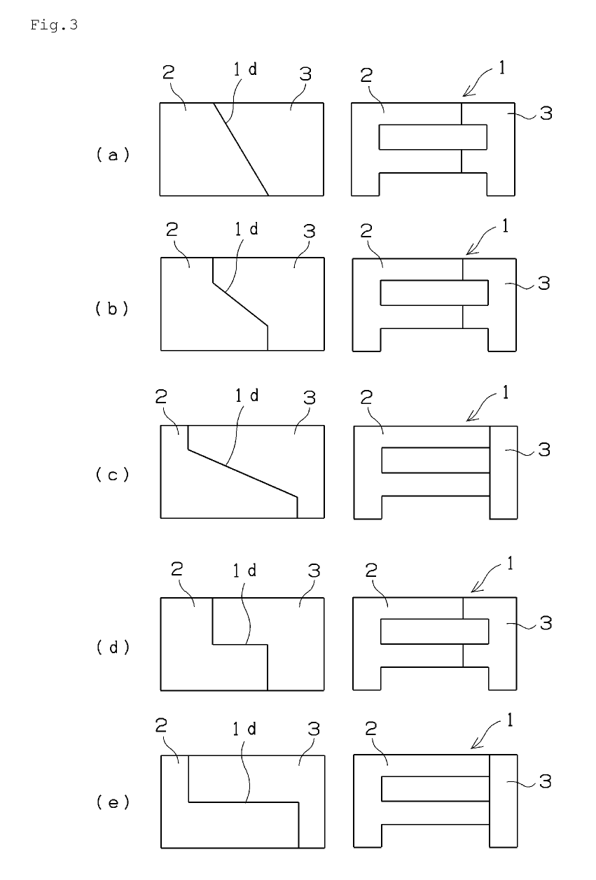

Another example of the magnetic core component of the present invention will be described based on FIGS. 3(a) to 3(e). FIGS. 3(a) to 3(e) are a front view (right view) and a plan view (left view) of the magnetic core component. In the magnetic core component 1 shown in FIG. 3(a), the respective half-members have a shape in which the right triangular portion (tapered portion) and the leg portion are combined when seen in plan view. The joining surface 1d is formed as one plane inclined with respect to the axial direction of the winding shaft portion. Compared to the structure of FIG. 1(a), the inclination angle of the joining surface 1d is slightly small, and the joining area is also slightly small.

In the magnetic core component 1 shown in FIGS. 3(b) and 3(c), the joining surface 1d is a compound surface including surfaces (two) perpendicular to the axial direction of the winding shaft portion, and one surface inclined with respect to the axial direction of the winding shaft portion. With the arrangement of the surface inclined with respect to the axial direction of the winding shaft portion, the joining area becomes large compared to when configured from only surfaces perpendicular to the axial direction of the winding shaft portion. The inclination angle of the inclined surface differs between FIG. 3(b) and FIG. 3(c).

In the magnetic core component 1 shown in FIGS. 3(d) and 3(e), the joining surface 1d is a compound surface including surfaces (two) perpendicular to the axial direction of the winding shaft portion, and a surface that lies along the axial direction of the winding shaft portion. With the arrangement of the surface lying along the axial direction of the winding shaft portion, the joining area becomes large by an area of the surface lying along the axial direction of the winding shaft portion compared to when configured from only surfaces perpendicular to the axial direction of the winding shaft portion. The area of the surface that lies along the axial direction of the winding shaft portion differs between FIG. 3(d) and FIG. 3(e).

The half-members 2, 3 have the same shape in any of FIGS. 3(a) to 3(e), and can be manufactured with one type of mold. Furthermore, as described above, a wide joining area can be ensured in any case, and the actual contacting area also becomes large, so that the gap between the members can be reduced and the leakage flux can be suppressed compared to the shape shown in FIG. 4(b).

The half-member is a magnetic body, and the method for manufacturing the same is not particularly limited, but a compression molded body of a magnetic material is preferably adopted as it can be inexpensively manufactured and can be easily miniaturized compared to injection molded body. As the magnetic core component of the present invention is formed as a member having a simple shape as described above, it can be sufficiently molded even with compression molding.

The half-member uses, as a raw material, pure iron soft magnetic material including iron powder and iron nitride powder; iron-base alloy soft magnetic material including Fe—Si—Al alloy (sendust) powder, super sendust powder, Ni—Fe alloy (permalloy) powder, Co—Fe alloy powder, and Fe—Si—B alloy powder; and magnetic material including ferrite magnetic material, amorphous magnetic material, and microcrystalline material. The ferrite magnetic material includes manganese zinc ferrite, nickel zinc ferrite, copper zinc ferrite, spinel ferrite having a spinel type crystalline structure such as magnetite, barium ferrite, hexagonal ferrite such as strontium ferrite, garnet ferrite such as yttrium iron garnet, and the like. The amorphous magnetic material includes iron alloy, cobalt alloy, nickel alloy, mixed alloy amorphous thereof, and the like.

Examples of an oxide that forms an insulating coating on a particle surface of the magnetic material to become the raw material include an oxide of insulating metal or metalloid including Al₂O₃, Y₂O₃, MgO, ZrO₂, and the like, glass, and a mixture thereof. For a method for forming the insulating coating, powder coating method such as mechano-fusion, wet thin-film production method such as electroless plating and sol-gel method, or dry thin-film production method such as sputtering can be used.

An average particle diameter of the raw material powder is preferably 1 to 150 μm, and more preferably 5 to 100 μm. If the average particle diameter is smaller than 1 μm, compressibility (scale indicating easiness of hardening of powder) at the time of pressurization molding lowers, and the material strength after burning significantly lowers. If the average particle diameter is greater than 150 μm, the iron loss in a high frequency region becomes large, and the magnetic property (frequency property) lowers.

The half-member, which is a compression molded body, can be manufactured as follows: a raw material powder simple body of magnetic material, where the insulating coating is formed on the particle surface, or a powder in which the thermosetting resin such as an epoxy resin is combined in the raw material powder is press-molded at a predetermined pressurization force to obtain a powder body; and this powder body is burned. Since the half-members have the same shape, the mold used is one type. When using an amorphous alloy powder for the raw material, the burning temperature needs to be lower than a crystallization start temperature of the amorphous alloy. Furthermore, when using the powder combined with the thermosetting resin, the burning temperature needs to be in a hardening temperature range of the resin.

The two obtained half-members are joined to complete the magnetic core component. The joining of the members can be carried out using an adhesive and the like in addition to the fitting-in by the positioning shape described above. A solventless epoxy adhesive that can be closely attached to each other is preferred for the adhesive.

In the obtained magnetic core component, the winding wire is wound around the winding shaft portion to form the coil, thus obtaining the chip inductor with an inductor function. A copper enamel wire can be used for the winding wire, and examples of the type of wire that can be used include urethane wire (UEW), formal wire (PVF), polyester wire (PEW), polyester imide wire (EIW), polyamide imide wire (AIW), polyimide wire (PIW), double coated wire combining the same, or self-welding wire, litz wire, and the like. The polyamide imide wire (AIW), the polyimide wire (PIW), and the like excelling in heat resistance are preferred. The cross-sectional shape of the copper enamel wire that can be adopted may be round or square. The known method can be adopted for the manner of winding the coil and the like.

The embodiment of the present invention has been described above based on the figures, but the magnetic core component and the chip inductor of the present invention are not limited thereto.

### INDUSTRIAL APPLICABILITY

The magnetic core component of the present invention can suppress the leakage flux while suppressing the number of molds required at the time of molding, and thus can be suitably used as a core for the chip inductor used in the electronic circuit of various types of electric/electronic equipment.

### EXPLANATION OF REFERENCE NUMERALS AND SYMBOLS

1 magnetic core component
2 half-member
3 half member
4 winding wire
5 electrode unit
6 chip inductor
7 substrate

1. A magnetic core component including a winding shaft portion for winding a winding wire; wherein
the magnetic core component is formed by joining two half-members, which are magnetic bodies and have the same shape, at least one part of a joining surface being a surface non-perpendicular to an axial direction of the winding shaft portion.

2. The magnetic core component according to claim 1, wherein
the magnetic core component includes a leg portion arranged at both ends of the winding shaft portion, and a cover portion arranged across one end of the leg portions in parallel with the winding shaft portion, the joining surface being formed in the winding shaft portion and the cover portion.

3. The magnetic core component according to claim 1, wherein the half-member is a compression molded body of a magnetic material.

4. The magnetic core component according to claim 1, wherein the two half-members have complementary fit-in shapes that position the members at respective joining parts.

5. A chip inductor obtained by winding a winding wire around a winding shaft portion of a magnetic core component and forming a coil, wherein the magnetic core component is the magnetic core component according to claim 1.
